(19) United States
(12) Patent Application Publication
(10) Pub. No.: US 2017/0206426 A1
(43) Pub. Date: Jul. 20, 2017

(54) Pedestrian Detection With Saliency Maps

(71) Applicant: Ford Global Technologies, LLC, Dearborn, MI (US)

(72) Inventors: Madeline Jane Schrier, Palo Alto, CA (US); Vidya Nariyambut Murali, Sunnyvale, CA (US); Gint Puskorius, Novi, MI (US)

(21) Appl. No.: 14/997,120

(22) Filed: Jan. 15, 2016

(51) Int. Cl. G06K 9/00; G05D 1/00; G06T 7/00; G06N 3/08

(52) U.S. Cl. CPC G06K 9/00805; G06N 3/08; G05D 1/0088; G06T 7/004; G06T 2207/10004; G06T 2207/30252; G06T 2207/30196; G06T 2207/20084

(57) ABSTRACT

Systems, methods, and devices for pedestrian detection are disclosed herein. A method includes receiving an image of a region near a vehicle. The method further includes processing the image using a first neural network to determine one or more locations where pedestrians are likely located within the image. The method also includes processing the one or more locations of the image using a second neural network to determine that a pedestrian is present and notifying a driving assistance system or automated driving system that the pedestrian is present.

### TECHNICAL FIELD

The disclosure relates generally to methods, systems, and apparatuses for automated driving or for assisting a driver, and more particularly relates to methods, systems, and apparatuses for detecting one or more pedestrians using machine learning and saliency maps.

### BACKGROUND

Automobiles provide a significant portion of transportation for commercial, government, and private entities. Autonomous vehicles and driving assistance systems are currently being developed and deployed to provide safety, reduce an amount of user input required, or even eliminate user involvement entirely. For example, some driving assistance systems, such as crash avoidance systems, may monitor driving, positions, and a velocity of the vehicle and other objects while a human is driving. When the system detects that a crash or impact is imminent the crash avoidance system may intervene and apply a brake, steer the vehicle, or perform other avoidance or safety maneuvers. As another example, autonomous vehicles may drive and navigate a vehicle with little or no user input. However, due to the dangers involved in driving and the costs of vehicles, it is extremely important that autonomous vehicles and driving assistance systems operate safely and are able to accurately navigate roads and avoid other vehicles and pedestrians.

### BRIEF DESCRIPTION OF THE DRAWINGS

Non-limiting and non-exhaustive implementations of the present disclosure are described with reference to the following figures, wherein like reference numerals refer to like parts throughout the various views unless otherwise specified. Advantages of the present disclosure will become better understood with regard to the following description and accompanying drawings where:

FIG. 1 is a schematic block diagram illustrating an example implementation of a vehicle control system that includes an automated driving/assistance system;

FIG. 2 illustrates an image of a roadway;

FIG. 3 illustrates a schematic of a saliency map for the image of FIG. 2, according to one implementation;

FIG. 4 is a schematic block diagram illustrating pedestrian detection, according to one implementation;

FIG. 5 is a schematic block diagram illustrating example components of a pedestrian component, according to one implementation; and

FIG. 6 is a schematic block diagram illustrating a method for pedestrian detection, according to one implementation.

### DETAILED DESCRIPTION

In order to operate safely, an intelligent vehicle should be able to quickly and accurately recognize a pedestrian. For active safety and driver assistance applications a common challenge is to quickly and accurately detect a pedestrian and the pedestrian's location in a scene. Some classification solutions have been achieved with great success utilizing deep neural networks. However, detection and localization are still challenging as pedestrians are present in different scales and at different locations. For example, current detection and localization techniques are not able to match a human's ability to ascertain a scale and location of interesting objects in a scene and/or quickly understand the “gist” of the scene.

In the present disclosure, Applicants present systems, devices, and methods that improve automated pedestrian localization and detection. In one embodiment, a method for detecting pedestrians includes receiving an image of a region near a vehicle and processing the image using a first neural network to determine one or more locations where pedestrians are likely located within the image. The method further includes processing the one or more locations of the image using a second neural network to determine that a pedestrian is present. The method also includes notifying a driving assistance system or automated driving system that the pedestrian is present.

According to one embodiment, an improved method for pedestrian localization and detection uses a two-stage computer vision based deep learning technique. In a first stage, one or more regions of an image obtained from the vehicle's perception sensors and sensor data are identified as more likely including pedestrians. The first stage may produce indications of likely regions where pedestrian are in the form of a saliency map or other indication(s) of a region of an image where pedestrians are likely located. Applicants have recognized that psycho-visual studies have shown that gaze fixations from lower-resolution images can predict fixations on higher-resolution images. As such, some embodiments may produce effective saliency maps at a low-resolution. These low-resolution saliency maps may be used as labels for corresponding images. In one embodiment, a deep neural network may be trained to output a saliency map for any image based on training data. In one embodiment, a saliency map will indicate regions of an image that most likely contain a pedestrian. Saliency maps remain effective even at very low resolutions, allowing faster processing by reducing the search space while still accurately detecting pedestrians in an environment.

In a second stage, a deep neural network classifier may be used to determine whether a pedestrian is actually present within one or more regions identified in the first stage. In one embodiment, the second stage may use a deep neural network classifier, including variations on deep networks disclosed in “ImageNet Classification with Deep Convolutional Neural Networks,” by A. Krizhevsky, I. Sutskever, G. Hinton (Neural Information Processing Systems Conference 2012). In one embodiment, a convolutional neural network may be trained on cropped ground truth bounding boxes of both positive and negative pedestrian data. Specific parts of the image as identified in the first stage can be selected and identified as candidate regions. These candidate regions can be fed into the trained deep neural network, which classifies the potential pedestrians. A large deep neural network can be configured and trained to achieve a high percentage of accuracy and low false negatives. One or both of the first stage neural network and the second stage neural network may be trained on existing datasets, such as the Caltech Pedestrian Dataset, internal datasets from fleet vehicles, and/or simulated data from related projects.

One example, of pedestrian network detection was presented in “Pedestrian Detection with a Large-Field-Of-View Deep Network, A. Angelova, A. Krizhevsky, V. Vanhoucke (IEEE International Conference on Robotics and Automation ICRA 2015). The large field of view networks developed by Angelova et al. presented pedestrian detection and rapid localization. However, Angelova et al. does not utilize saliency for localization, but instead requires the additional generation of a separate grid-based dataset of pedestrian location images, ignoring pedestrians that overlap grids and enforcing grid enclosure for detection. Thus, they have a pedestrian miss rate that is higher than needed to be viable for active safety applications. In contrast, at least some embodiments of the present disclosure require no sliding window and thus eliminate one of the most computationally expensive aspects of state-of-art deep learning techniques.

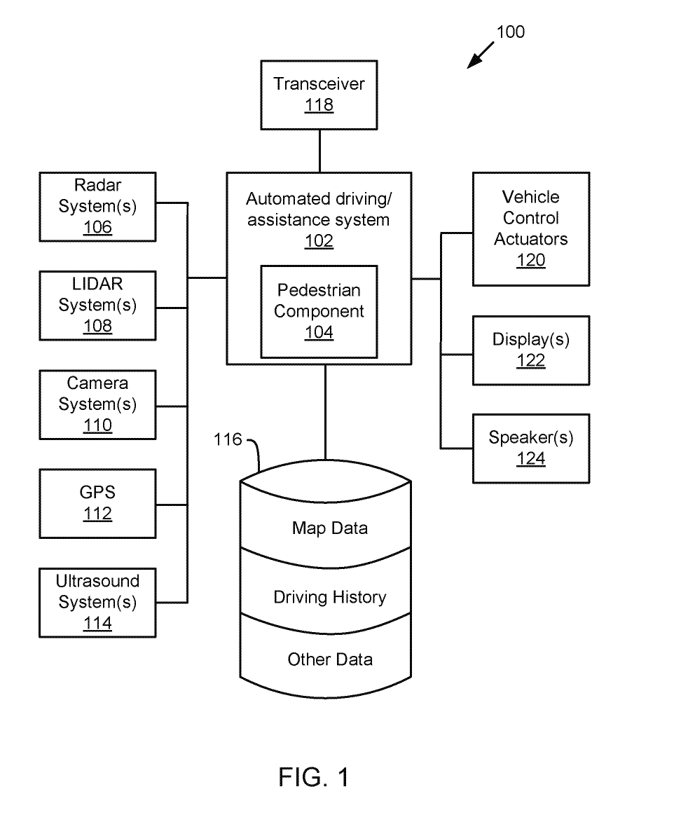

Referring now to the figures, FIG. 1 illustrates an example vehicle control system 100 that includes an automated driving/assistance system 102. The automated driving/assistance system 102 may be used to automate, assist, or control operation of a vehicle, such as a car, truck, van, bus, large truck, emergency vehicles or any other automobile for transporting people or goods, or to provide assistance to a human driver. For example, the automated driving/assistance system 102 may control one or more of braking, steering, acceleration, lights, alerts, driver notifications, radio, or any other auxiliary systems of the vehicle. In another example, the automated driving/assistance system 102 may not be able to provide any control of the driving (e.g., steering, acceleration, or braking), but may provide notifications and alerts to assist a human driver in driving safely. The automated driving/assistance system 102 includes a pedestrian component 104, which may localize and detect pedestrians near a vehicle or near a driving path of the vehicle. For example, the pedestrian component 104 may determine one or more regions within an image that have a higher likelihood of containing a pedestrian and then processing the one or more regions to determine whether a pedestrian is present in the regions. As another example, the pedestrian component 104 may produce a saliency map for an image and then process the image based on the saliency map to detect or localize a pedestrian in the image or with respect to a vehicle.

The vehicle control system 100 also includes one or more sensor systems/devices for detecting a presence of nearby objects or determining a location of a parent vehicle (e.g., a vehicle that includes the vehicle control system 100) or nearby objects. For example, the vehicle control system 100 may include one or more radar systems 106, one or more LIDAR systems 108, one or more camera systems 110, a global positioning system (GPS) 112, and/or one or more ultrasound systems 114.

The vehicle control system 100 may include a data store 116 for storing relevant or useful data for navigation and safety such as map data, driving history or other data. The vehicle control system 100 may also include a transceiver 118 for wireless communication with a mobile or wireless network, other vehicles, infrastructure, or any other communication system. The vehicle control system 100 may include vehicle control actuators 120 to control various aspects of the driving of the vehicle such as electric motors, switches or other actuators, to control braking, acceleration, steering or the like. The vehicle control system 100 may also include one or more displays 122, speakers 124, or other devices so that notifications to a human driver or passenger may be provided. The display 122 may include a heads-up display, a dashboard display or indicator, a display screen, or any other visual indicator, which may be seen by a driver or passenger of a vehicle. The speakers 124 may include one or more speakers of a sound system of a vehicle or may include a speaker dedicated to driver notification.

It will be appreciated that the embodiment of FIG. 1 is given by way of example only. Other embodiments may include fewer or additional components without departing from the scope of the disclosure. Additionally, illustrated components may be combined or included within other components without limitation. For example, the pedestrian component 104 may be separate from the automated driving/assistance system 102 and the data store 116 may be included as part of the automated driving/assistance system 102 and/or part of the pedestrian component 104.

The radar system 106 may operate by transmitting radio signals and detecting reflections off objects. In ground applications, the radar may be used to detect physical objects, such as other vehicles, parking barriers or parking chocks, landscapes (such as trees, cliffs, rocks, hills, or the like), road edges, signs, buildings, or other objects. The radar system 106 may use the reflected radio waves to determine a size, shape, distance, surface texture, or other information about a physical object or material. For example, the radar system 106 may sweep an area to obtain data about objects within a specific range and viewing angle of the radar system 106. In one embodiment, the radar system 106 is configured to generate perception information from a region near the vehicle, such as one or more regions nearby or surrounding the vehicle. For example, the radar system 106 may obtain data about regions of the ground or vertical area immediately neighboring or near the vehicle. The radar system 106 may include one of many widely available commercially available radar systems. In one embodiment, the radar system 106 may provide perception data including a two dimensional or three-dimensional map or model to the automated driving/assistance system 102 for reference or processing.

The LIDAR system 108 may operate by emitting visible wavelength or infrared wavelength lasers and detecting reflections of the laser light off objects. In ground applications, the lasers may be used to detect physical objects, such as other vehicles, parking barriers or parking chocks, landscapes (such as trees, cliffs, rocks, hills, or the like), road edges, signs, buildings, or other objects. The LIDAR system 108 may use the reflected laser light to determine a size, shape, distance, surface texture, or other information about a physical object or material. For example, the LIDAR system 108 may sweep an area to obtain data or objects within a specific range and viewing angle of the LIDAR system 108. For example, the LIDAR system 108 may obtain data about regions of the ground or vertical area immediately neighboring or near the vehicle. The LIDAR system 108 may include one of many widely available commercially available LIDAR systems. In one embodiment, the LIDAR system 108 may provide perception data including a two dimensional or three-dimensional model or map of detected objects or surfaces.

The camera system 110 may include one or more cameras, such as visible wavelength cameras or infrared cameras. The camera system 110 may provide a video feed or periodic images, which can be processed for object detection, road identification and positioning, or other detection or positioning. In one embodiment, the camera system 110 may include two or more cameras, which may be used to provide ranging (e.g., detecting a distance) for objects within view. In one embodiment, image processing may be used on captured camera images or video to detect vehicles, turn signals, drivers, gestures, and/or body language of a driver. In one embodiment, the camera system 110 may include cameras that obtain images for two or more directions around the vehicle.

The GPS system 112 is one embodiment of a positioning system that may provide a geographical location of the vehicle based on satellite or radio tower signals. GPS systems 112 are well known and widely available in the art. Although GPS systems 112 can provide very accurate positioning information, GPS systems 112 generally provide little or no information about distances between the vehicle and other objects. Rather, they simply provide a location, which can then be compared with other data, such as maps, to determine distances to other objects, roads, or locations of interest.

The ultrasound system 114 may be used to detect objects or distances between a vehicle and objects using ultrasonic waves. For example, the ultrasound system 114 may emit ultrasonic waves from a location on or near a bumper or side panel location of a vehicle. The ultrasonic waves, which can travel short distances through air, may reflect off other objects and be detected by the ultrasound system 114. Based on an amount of time between emission and reception of reflected ultrasonic waves, the ultrasound system 114 may be able to detect accurate distances between a bumper or side panel and any other objects. Due to its shorter range, ultrasound systems 114 may be more useful to detect objects during parking or to detect imminent collisions during driving.

In one embodiment, the radar system(s) 106, the LIDAR system(s) 108, the camera system(s) 110, and the ultrasound system(s) 114 may detect environmental attributes or obstacles near a vehicle. For example, the systems 106-110 and 114 may be used to detect and localize other vehicles, pedestrians, people, animals, a number of lanes, lane width, shoulder width, road surface curvature, road direction curvature, rumble strips, lane markings, presence of intersections, road signs, bridges, overpasses, barriers, medians, curbs, or any other details about a road. As a further example, the systems 106-110 and 114 may detect environmental attributes that include information about structures, objects, or surfaces near the road, such as the presence of drive ways, parking lots, parking lot exits/entrances, sidewalks, walkways, trees, fences, buildings, parked vehicles (on or near the road), gates, signs, parking strips, or any other structures or objects.

The data store 116 stores map data, driving history, and other data, which may include other navigational data, settings, or operating instructions for the automated driving/assistance system 102. The map data may include location data, such as GPS location data, for roads, parking lots, parking stalls, or other places where a vehicle may be driven or parked. For example, the location data for roads may include location data for specific lanes, such as lane direction, merging lanes, highway or freeway lanes, exit lanes, or any other lane or division of a road. The location data may also include locations for one or more parking stall in a parking lot or for parking stalls along a road. In one embodiment, the map data includes location data about one or more structures or objects on or near the roads or parking locations. For example, the map data may include data regarding GPS sign location, bridge location, building or other structure location, or the like. In one embodiment, the map data may include precise location data with accuracy within a few meters or within sub meter accuracy. The map data may also include location data for paths, dirt roads, or other roads or paths, which may be driven by a land vehicle.

The transceiver 118 is configured to receive signals from one or more other data or signal sources. The transceiver 118 may include one or more radios configured to communicate according to a variety of communication standards and/or using a variety of different frequencies. For example, the transceiver 118 may receive signals from other vehicles. Receiving signals from another vehicle is referenced herein as vehicle-to-vehicle (V2V) communication. In one embodiment, the transceiver 118 may also be used to transmit information to other vehicles to potentially assist them in locating vehicles or objects. During V2V communication the transceiver 118 may receive information from other vehicles about their locations, previous locations or states, other traffic, accidents, road conditions, the locations of parking barriers or parking chocks, or any other details that may assist the vehicle and/or automated driving/assistance system 102 in driving accurately or safely. For example, the transceiver 118 may receive updated models or algorithms for use by a pedestrian component 104 in detecting and localizing pedestrians or other objects.

The transceiver 118 may receive signals from other signal sources that are at fixed locations. Infrastructure transceivers may be located at a specific geographic location and may transmit its specific geographic location with a time stamp. Thus, the automated driving/assistance system 102 may be able to determine a distance from the infrastructure transceivers based on the time stamp and then determine its location based on the location of the infrastructure transceivers. In one embodiment, receiving or sending location data from devices or towers at fixed locations is referenced herein as vehicle-to-infrastructure (V2X) communication. V2X communication may also be used to provide information about locations of other vehicles, their previous states, or the like. For example, V2X communications may include information about how long a vehicle has been stopped or waiting at an intersection. In one embodiment, the term V2X communication may also encompass V2V communication.

In one embodiment, the automated driving/assistance system 102 is configured to control driving or navigation of a parent vehicle. For example, the automated driving/assistance system 102 may control the vehicle control actuators 120 to drive a path on a road, parking lot, through an intersection, driveway or other location. For example, the automated driving/assistance system 102 may determine a path and speed to drive based on information or perception data provided by any of the components 106-118. As another example, the automated driving/assistance system 102 may determine when to change lanes, merge, avoid obstacles or pedestrians, or when to leave space for another vehicle to change lanes, or the like.

In one embodiment, the pedestrian component 104 is configured to detect and localize pedestrians near a vehicle. For example, the pedestrian component 104 may process perception data from one or more of a radar system 106, LIDAR system 108, camera system 110, and ultrasound system 114 gathered in a region near a vehicle or in a direction of travel of the vehicle to detect the presence of pedestrians. The automated driving/assistance system 102 may then use that information to avoid pedestrians, alter a driving path, or perform a driving or avoidance maneuver.

As used herein, the term “pedestrian” is given to mean a human that is not driving a vehicle. For example, a pedestrian may include a person walking, running, sitting, or lying in an area perceptible to a perception sensor. Pedestrians may also include those using human powered devices such as bicycles, scooters, roller blades or roller skates, or the like. Pedestrians may be located on or near roadways, such as in cross walks, sidewalks, on the shoulder of a road, or the like. Pedestrians may have significant variation in size shape, or the like. For example, small babies, teenagers, seniors, or any other age human may be detected or identified as pedestrians. Similarly, pedestrians may vary significantly in a type or amount of clothing. Thus, the appearance of pedestrians to a camera or other sensor may be quite varied.

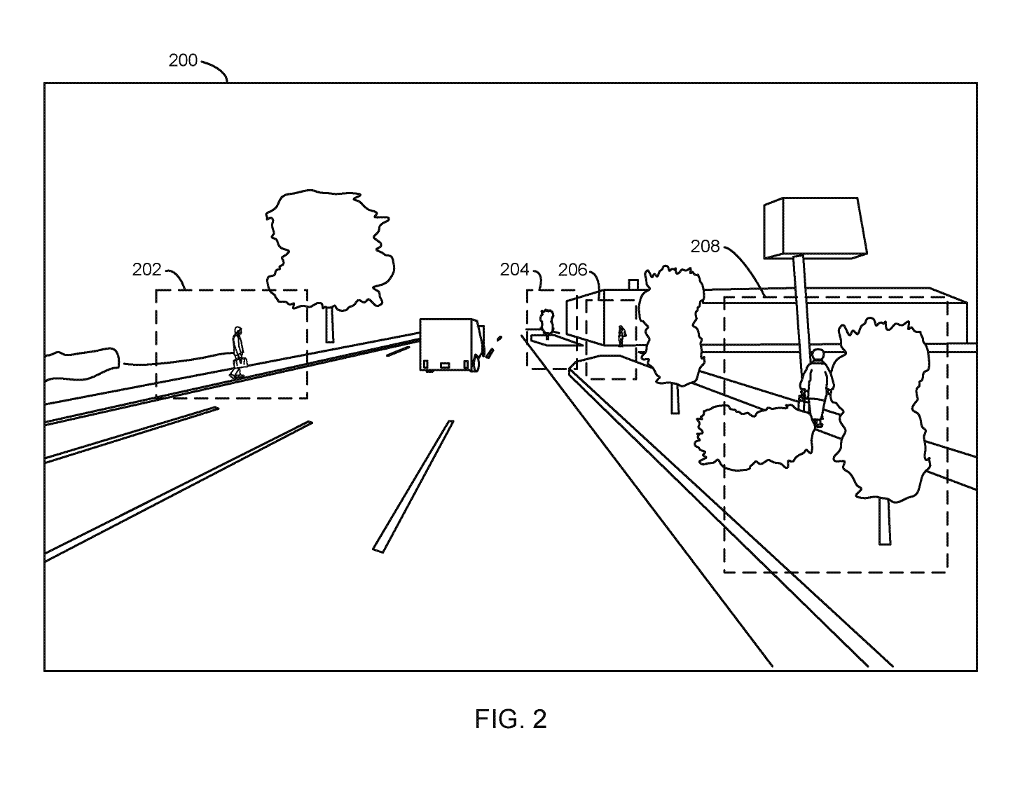

FIG. 2 illustrates an image 200 of a perspective view that may be captured by a camera of a vehicle control system 100. For example, the image 200 illustrates a scene of a road in front of a vehicle that may be captured while a vehicle is traveling down the road. The image 200 includes a plurality of pedestrians on or near the roadway. In one embodiment, the pedestrian component 104 may identify one or more regions of the image 200 that are likely to include a pedestrian. For example, the pedestrian component 104 may generate one or more bounding boxes or define one or more sub-regions of the image 200 where pedestrians may be located. In one embodiment, the pedestrian component 104 defines sub-regions 202-208 as regions where pedestrians are likely located. For example, the pedestrian component 104 may generate information that defines a location within the image for each of the sub-regions 202-208 in which pedestrians may be located and thus further analyzed or processed. In one embodiment, the pedestrian component 104 may process the image 200 using a neural network that has been trained to produce a saliency map that indicates regions where pedestrians may be located. The saliency map may specifically provide regions or locations where pedestrians are most likely located in the image 200.

Using the saliency map, or any other indication of regions where pedestrians may be located, the pedestrian component 104 may process sub-regions of the image 200 to classify the regions as including or not including a pedestrian. In one embodiment, the pedestrian component 104 may detect and localize one or more pedestrians within the image 200. For example, a first sub-region 202 does include a pedestrian, a second sub-region 204 does not include a pedestrian, but instead includes a tree, a third-sub region 206 includes a pedestrian, and fourth sub-region 208 includes a pedestrian.

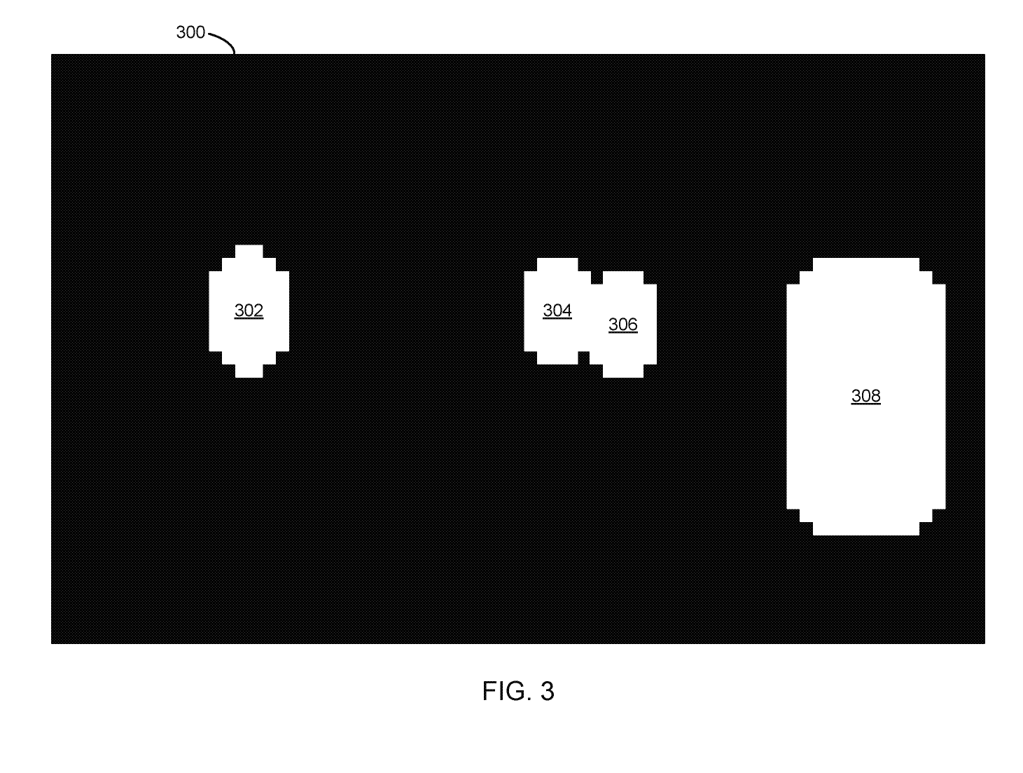

FIG. 3 is a schematic view of an embodiment of a saliency map 300 produced by the pedestrian component 104. The saliency map 300 may operate as a label for the image 200 of FIG. 2. For example, the pedestrian component 104 may process portions of the image corresponding to the locations 302-308 to attempt to detect and/or localize pedestrians. A first location 302, a second location 304, a third location 306, and a fourth location 308 may correspond to the first sub-region 202, the second sub-region 204, the third sub-region 206, and the fourth sub-region 208 of the image of FIG. 2. In one embodiment, the pedestrian component 104 may generate a modified image by overlaying or combining the saliency map 300 with the image 200 and process the modified image to detect pedestrians. For example, the modified image may be black (or some other color) except for in the locations 302-308 where the corresponding portions of the image 200 may remain at least partially visible or completely unchanged. The saliency map 300 may be scaled up and/or the image 200 may be scaled down in order to have a matching resolution so that pedestrian detection may be performed.

In one embodiment, the saliency map 300 may have a lower resolution than the image 200. For example, the saliency map 300 may have a standard size or may have a resolution reduced by a predefined factor. A discussed above, low resolution saliency maps can still be very effective and can also reduce processing workload or processing delay. In one embodiment, the pedestrian component 104 may process the image 200 based on the saliency map 300 by scaling up the saliency map 300. For example, the pedestrian component 104 may process multiple pixels of the image 200 in relation to the same pixels in the saliency map. Although the saliency map 300 of FIG. 3 is illustrated with black or white pixels, some embodiments may generate and use saliency maps having grayscale values.

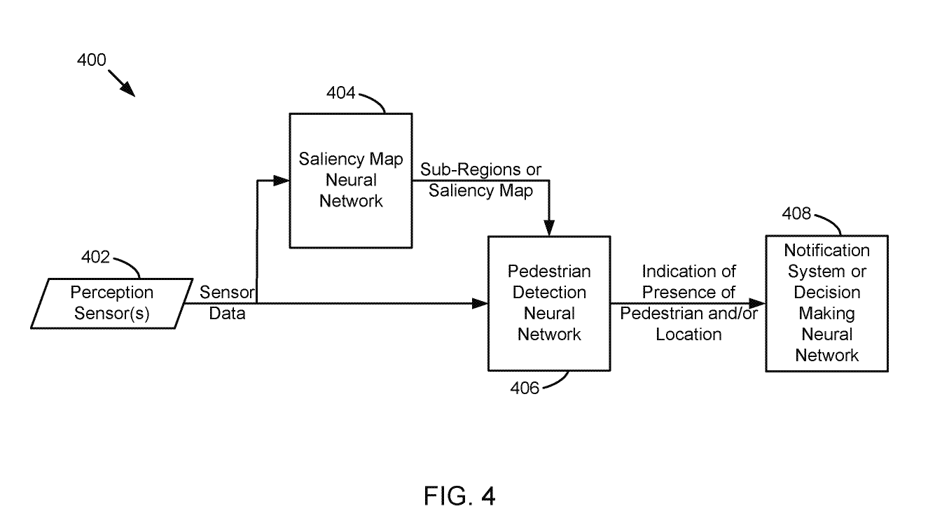

FIG. 4 is a schematic block diagram 400 illustrating pedestrian detection and localization, according to one embodiment. Perception sensors 402 output sensor data. The sensor data may include data from one or more of a radar system 106, LIDAR system 108, camera system 110, and an ultrasound system 114. The sensor data is fed into a saliency map neural network 404. The saliency map neural network processes the sensor data (such as an image or vector matrix) to produce a saliency map and/or an indication of one or more sub-regions of the sensor data that likely contain a pedestrian (or sensor data about a pedestrian). The saliency map or other indication of one or more sub-regions of the sensor data that likely contain a pedestrian, along with the sensor data, is fed into a pedestrian detection neural network 406 for classification and/or localization. For example, the pedestrian detection neural network 406 may classify the sensor data or each sub-region identified by the saliency map neural network 404 as containing or not containing a pedestrian. Additionally, the pedestrian detection neural network 406 may determine a specific location or region within the sensor data (e.g., may identify a plurality of pixels within an image) where the pedestrian is located. The pedestrian detection neural network 406 outputs an indication of the presence and/or location of the pedestrian to a notification system or decision making neural network 408. For example, the presence of a pedestrian and/or the pedestrian's location may be provided to a notification system to notify a driver or a driving system of a vehicle. As another example, the presence of a pedestrian and/or the pedestrian's location may be provided as input to a decision making neural network. For example, the decision making neural network may make a driving decision or other operational decision for the automated driving/assistance system 102 based on the output of the pedestrian detection neural network 406. In one embodiment, decision making neural network may decide on a specific driving maneuver, driving path, driver notification, or any other operational decision based on the indication of presence or location of the pedestrian.

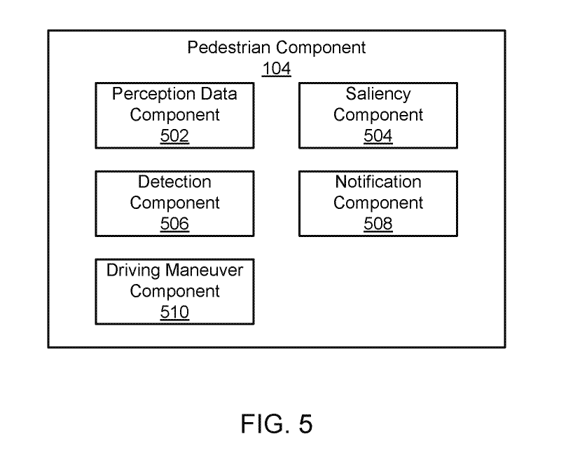

FIG. 5 is a schematic block diagram illustrating components of a pedestrian component 104, according to one embodiment. The pedestrian component 104 includes a perception data component 502, a saliency component 504, a detection component 506, a notification component 508, and a driving maneuver component 510. The components 502-510 are given by way of illustration only and may not all be included in all embodiments. In fact, some embodiments may include only one or any combination of two or more of the components 502-510. Some of the components 502-510 may be located outside the pedestrian component 104, such as within the automated driving/assistance system 102 of FIG. 1 or elsewhere without departing from the scope of the disclosure.

The perception data component 502 is configured to receive sensor data from one or more sensor systems of the vehicle. For example, the perception data component 502 may receive data from the radar system 106, the LIDAR system 108, the camera system 110, the GPS 112, the ultrasound system 114, or the like. In one embodiment, the perception data may include perception data for one or more regions near the vehicle. For example, sensors of the vehicle may provide a 360 degree view around the vehicle. In one embodiment, the camera system 110 captures an image of a region near the vehicle. The perception data may include data about pedestrians near the vehicle. For example, the camera system 110 may capture a region in front of, or to the side or rear of the vehicle, where one or more pedestrians may be located. For example, pedestrians crossing a street, walking near a roadway, or in a parking lot may be captured in the image or other perception data.

The saliency component 504 is configured to process perception data received from one or more sensor systems to identify locations where pedestrians may be located. For example, if an image, such as image 200 in FIG. 2, is received from a camera system 110, the saliency component 504 may process the image to determine one or more locations where pedestrians are likely located within the image. In one embodiment, the saliency component 504 may produce information defining a sub-region of the image where a pedestrian is most likely located. For example, the saliency component 504 may produce one or more x-y coordinates to define a location or bounded area of the image where a pedestrian may be located. The sub-region may include or define a rectangular or elliptical area within the image. In one embodiment, the saliency component 504 is configured to generate a saliency map for the perception data.

The saliency component 504 may process the perception data, such as an image, using a neural network. For example each pixel value of an image may be fed into a neural network that has been trained to identify regions within the image that are likely, or most likely, when compared to other regions of an image, to include pedestrians. In one embodiment, the neural network includes a network trained to identify approximate locations within images, or other perception data, that likely contain pedestrians. The neural network may include a deep convolutional network that has been trained for quickly identifying sub-regions that are likely to included pedestrians. The sub-regions identified by the neural network may be regions that likely include pedestrians with a low level of false negatives, but with potentially a higher level of false positives. For example, the identification of sub-regions may be over inclusive in that some regions may not actually include a pedestrian while the identification of sub-regions also has a low probability of missing a region where a pedestrian is located. Following identification of the sub-regions that likely include a pedestrian, a second neural network or algorithm may be used to analyze the identified sub-regions to determine whether pedestrian is in-fact present. In one embodiment, the output of the neural network or saliency component 504 is an x-y coordinate of an image and one or more distance parameters defining a distance from the x-y coordinate that are included within a sub-region. For example, the distance parameters may define the edges of a rectangular or elliptical sub-region of the image.

In one embodiment, the output of the neural network or the saliency component 504 is a saliency map. For example, the neural network may generate a saliency map indicating most likely locations of pedestrians. In one embodiment, the neural network may be configured to operate at a lower resolution than an image or other information gathered by a perception sensor system. For example, the neural network may process a low resolution version of the image to produce the saliency map. As another example, the neural network may process a full resolution image and produce a low resolution saliency map. In one embodiment, both an input resolution for the neural network and an output resolution for a saliency map are lower than a full resolution of an image or other data gathered by the perception data component 502. In one embodiment, low resolution saliency maps may provide performance as good as or nearly as good as full resolution saliency maps while requiring fewer computing resources and/or resulting in quicker processing times.

The saliency map that results from processing using the neural network may include a saliency map that indicates locations where pedestrians are likely located. For example, the neural network may be trained with images and ground truth identifying regions where pedestrians are or are not present. Thus, the output of the neural network and/or the saliency component 504 is a pedestrian location saliency map. This is different than some saliency maps that attempt to predict or indicate locations where a human's eye is naturally directed when looking at an image because it is specific to pedestrian locations. Identification of locations where pedestrians are likely located may significantly reduce processing power required to detect pedestrians because much less than a full image may need to be processed for object detection or a smaller neural network may be used.

In one embodiment, the saliency component 504 may prioritize one or more locations identified as likely having pedestrians. For example, the locations may be prioritized in order of likelihood that a pedestrian is present. These locations may then be processed in order of priority to facilitate speed in identifying pedestrians. For example, a first region may be most likely and a second region may be less likely to include a pedestrian, based on processing using the neural network. By searching the first region first, the chances that a pedestrian will be located sooner may be significantly increased. Similarly, the one or more locations may be prioritized based on position in relation to a path to be traveled by a vehicle. For example, locations closer to a vehicle or along a driving path of the vehicle may be prioritized over locations that are farther away from the vehicle or far away from a path of the vehicle.

The detection component 506 is configured to detect a presence of a pedestrian within an image or other perception data. For example, the detection component 506 may process image data to detect a human pedestrian or other human using object recognition or any image processing techniques. In one embodiment, the detection component 506 may localize the pedestrian within the image or perception data. For example, the detection component 506 may identify one or more pixels that correspond to the pedestrian. In one embodiment, the detection component 506 may localize the pedestrian with respect to a vehicle (for example with respect to a camera on the vehicle that captured the image). The detection component 506 may determine a distance between the sensor and the pedestrian and/or a direction relative to a front or driving direction of the vehicle and the pedestrian.

In one embodiment, the detection component 506 detects pedestrians by processing sub-regions identified by the saliency component 504. For example, rather than processing an image as a whole, the detection component 506 may only process regions of the image identified by the saliency component as likely, or more likely, containing a pedestrian. For example, the detection component 506 may process each sub-region separately to confirm or determine that a pedestrian is or is not present within the specific region. As another example, an image generated by combining an image and a saliency map (e.g., using a threshold or other effect) defined by the saliency component 504 may be processed by the detection component 506 to locate pedestrians. The saliency map may “black out,” “blur,” or otherwise hide portions of the image that are not likely to include pedestrians while allowing the other portions to be processed by the detection component 506.

In one embodiment, the detection component 506 is configured to process an image, or one or more sub-portions of an image, using a neural network. For example, the neural network used to detect pedestrians may be a different neural network than used by the saliency component 504. In one embodiment, the neural network may include a deep convolutional neural network that has been trained to detect pedestrians with high accuracy and a low false negative rate. In one embodiment, the detection component 506 may use a saliency map or other indication of sub-regions generated by the saliency component 504 to process a full-resolution version of the image, or sub-portion of the image. For example, the detection component 506 may use a low resolution saliency map to identify regions of the image that need to be processed, but then process those regions at an elevated or original image resolution.

In one embodiment, the detection component 506 may use a neural network that has been trained using cropped ground truth bounding boxes to determine that a pedestrian is or is not present. The neural network may be a classifier that classifies an image, or a portion of an image) as containing a pedestrian or not containing a pedestrian. For example, the detection component 506 may classify each portion identified by the saliency component 504 as including or not including a pedestrian. For example, in relation to FIG. 2, the saliency component 504 may identify each of the first, second, third, and fourth sub-regions 202-208 as likely including a pedestrian while the detection component 506 confirms that a pedestrian is present in the first, third, and fourth sub-regions 202, 206, 208, but determines that the second sub-region 204 does not include a pedestrian.

In one embodiment, the detection component 506 may process regions identified by the saliency component in order of priority. For example, locations with higher priority may be processed first to determine whether a pedestrian is present. Processing in order of priority may allow for increased speed in detecting pedestrians and allowing for quicker response times to prevent accidents, collision, or path planning.

The notification component 508 is configured to provide one or more notifications to a driver or automated driving system of a vehicle. In one embodiment, the notification component 508 may provide notifications to a driver using a display 122 or speaker 124. For example, a location of the pedestrian may be indicated on a heads-up display. In one embodiment, the notification may include an instruction to perform a maneuver or may warn that a pedestrian is present. In one embodiment, the notification component 508 may notify the driver or automated driving system 100 of a driving maneuver selected or suggested by the driving maneuver component 510. In one embodiment, the notification component 508 may notify the driver or automated driving system 100 of a location of the pedestrian so that path planning or collision avoidance may be performed accordingly. Similarly, the notification component 508 may provide an indication of a location of each pedestrian detected to an automated driving system 100 to allow for path planning or collision avoidance.

The driving maneuver component 510 is configured to select a driving maneuver for a parent vehicle based on the presence or absence of a pedestrian. For example, the driving maneuver component 510 may receive one or more pedestrian locations from the notification component 508 or the detection component 506. The driving maneuver component 510 may determine a driving path to avoid collision with the pedestrian or to allow room to maneuver in case the pedestrian moves in an expected or unexpected manner. For example, the driving maneuver component 510 may determine whether and when to decelerate, accelerate, and/or turn a steering wheel of the parent vehicle. In one embodiment, the driving maneuver component 510 may determine the timing for the driving maneuver. For example, the driving maneuver component 510 may determine that a parent vehicle should wait to perform a lane change or proceed through an intersection due to the presence of a pedestrian.

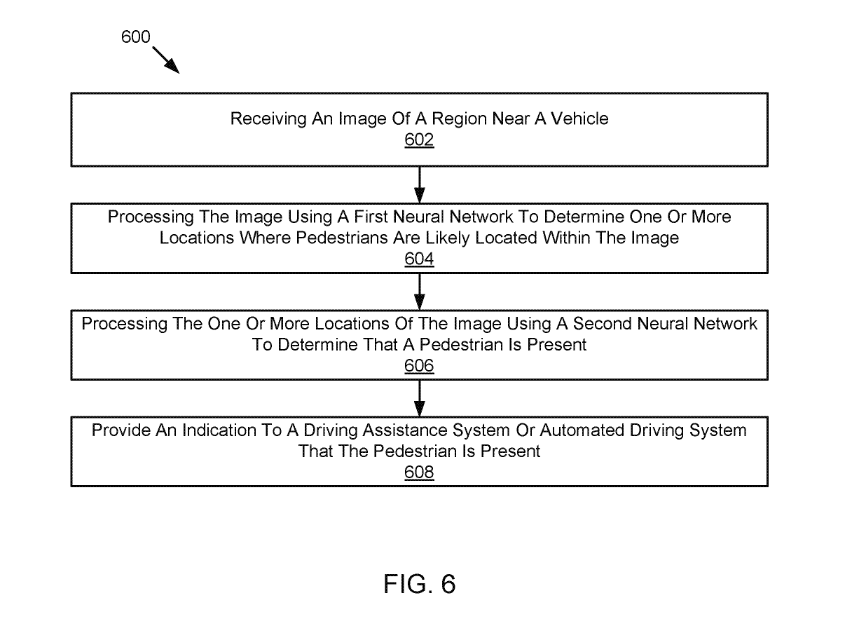

Referring now to FIG. 6, one embodiment of a schematic flow chart diagram of a method 600 for pedestrian detection is illustrated. The method 600 may be performed by an automated driving/assistance system or a pedestrian component, such as the automated driving/assistance system 102 of FIG. 1 or the pedestrian component 104 of FIG. 1 or 5.

The method 600 begins and a perception data component 502 receives an image of a region near a vehicle at 602. A saliency component 504 processes the image using a first neural network to determine one or more locations where pedestrians are likely located within the image at 604. A detection component 506 processes the one or more locations of the image using a second neural network to determine that a pedestrian is present at 606. A notification component 508 provides an indication to a driving assistance system or automated driving system that the pedestrian is present at 608.

Although various embodiments and examples described herein have been directed to detecting pedestrians based on camera images, some embodiments may operate on perception data gathered from other types of sensors, such as radar systems 106, LIDAR systems 108, ultrasound systems 114, or any other type of sensor or sensor system.

### EXAMPLES

The following examples pertain to further embodiments.

Example 1 is a method for detecting pedestrians that includes receiving an image of a region near a vehicle. The method also includes processing the image using a first neural network to determine one or more locations where pedestrians are likely located within the image. The method also includes processing the one or more locations of the image using a second neural network to determine that a pedestrian is present. The method includes notifying a driving assistance system or automated driving system that the pedestrian is present.

In Example 2, the first neural network in Example 1 includes a network trained to identify approximate locations within images that likely contain pedestrians.

In Example 3, the first neural network in any of Examples 1-2 generates a saliency map indicating most likely locations of pedestrians.

In Example 4, the saliency map of Example 3 includes a lower resolution than the image.

In Example 5, the second neural network in any of Examples 1-4 processes the one or more locations within the image at full resolution.

In Example 6, the second neural network in any of Examples 1-5 includes a deep neural network classifier that has been trained using cropped ground truth bounding boxes to determine that a pedestrian is or is not present.

In Example 7, determining that a pedestrian is present in any of Examples 1-6 includes determining whether a pedestrian is present in each of the one or more locations.

In Example 8, the method of any of Examples 1-7 further includes determining a location of the pedestrian in relation to the vehicle based on the image.

In Examples 9, the method of any of Examples 1-8 further includes determining a priority for the one or more locations, wherein processing the one or more locations comprises processing using the second neural network based on the priority.

Example 10 is a system that includes one or more cameras, a saliency component, a detection component, and a notification component. The one or more cameras are positioned on a vehicle to capture an image of a region near the vehicle. The saliency component is configured to process the image using a first neural network to generate a low resolution saliency map indicating one or more regions where pedestrians are most likely located within the image. The detection component is configured to process the one or more regions using a second neural network to determine, for each of one or more regions, whether a pedestrian is present. The notification component is configured to provide a notification indicating a presence or absence of pedestrians.

In Example 11, the saliency map of Example 10 includes a lower resolution than the image.

In Example 12, the detection component in any of Examples 10-11 uses the second neural network to process the one or more locations within the image at full resolution.

In Example 13, the second neural network in any of Examples 10-12 includes a deep neural network classifier that has been trained using cropped ground truth bounding boxes to determine that a pedestrian is or is not present.

In Example 14, the detection component in any of Examples 10-13 is configured to determine whether a pedestrian is present in each of the one or more regions.

In Example 15, the notification component in any of Examples 10-14 is configured to provide the notification to one or more of an output device to notify a driver and an automated driving system.

In Example 16, the system of any of Examples 10-15 further includes a driving maneuver component configured to determine a driving maneuver for the vehicle to perform.

Example 17 is computer readable storage media storing instructions that, when executed by one or more processors, cause the one or more processors to receive an image of a region near a vehicle. The instructions further cause the one or more processors to process the image using a first neural network to determine one or more locations where pedestrians are likely located within the image. The instructions further cause the one or more processors to process the one or more locations of the image using a second neural network to determine that a pedestrian is present. The instructions further cause the one or more processors to provide an indication to a driving assistance system or automated driving system that the pedestrian is present.

In Example 18, processing the image using a first neural network in Example 17 includes generating a saliency map indicating the one or more locations, wherein the saliency map comprises a lower resolution than the image.

In Example 19, the instructions in any of Examples 17-18 further cause the one or more processors to determine whether a pedestrian is present in each of the one or more locations.

In Example 20, the instructions in any of Examples 17-19 cause the one or more processors to determine a priority for the one or more locations and process the one or more locations based on the priority.

Example 21 is a system or device that includes means for implementing a method or realizing a system or apparatus in any of Examples 1-20.

In the above disclosure, reference has been made to the accompanying drawings, which form a part hereof, and in which is shown by way of illustration specific implementations in which the disclosure may be practiced. It is understood that other implementations may be utilized and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

As used herein, “autonomous vehicle” may be a vehicle that acts or operates completely independent of a human driver; or may be a vehicle that acts or operates independent of a human driver in some instances while in other instances a human driver may be able to operate the vehicle; or may be a vehicle that is predominantly operated by a human driver, but with the assistance of an automated driving/assistance system.

Implementations of the systems, devices, and methods disclosed herein may comprise or utilize a special purpose or general-purpose computer including computer hardware, such as, for example, one or more processors and system memory, as discussed herein. Implementations within the scope of the present disclosure may also include physical and other computer-readable media for carrying or storing computer-executable instructions and/or data structures. Such computer-readable media can be any available media that can be accessed by a general purpose or special purpose computer system. Computer-readable media that store computer-executable instructions are computer storage media (devices). Computer-readable media that carry computer-executable instructions are transmission media. Thus, by way of example, and not limitation, implementations of the disclosure can comprise at least two distinctly different kinds of computer-readable media: computer storage media (devices) and transmission media.

Computer storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

An implementation of the devices, systems, and methods disclosed herein may communicate over a computer network. A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links, which can be used to carry desired program code means in the form of computer-executable instructions or data structures and which can be accessed by a general purpose or special purpose computer. Combinations of the above should also be included within the scope of computer-readable media.

Computer-executable instructions comprise, for example, instructions and data which, when executed at a processor, cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, an in-dash vehicle computer, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, various storage devices, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Further, where appropriate, functions described herein can be performed in one or more of: hardware, software, firmware, digital components, or analog components. For example, one or more application specific integrated circuits (ASICs) can be programmed to carry out one or more of the systems and procedures described herein. Certain terms are used throughout the description and claims to refer to particular system components. As one skilled in the art will appreciate, components may be referred to by different names. This document does not intend to distinguish between components that differ in name, but not function.

It should be noted that the sensor embodiments discussed above may comprise computer hardware, software, firmware, or any combination thereof to perform at least a portion of their functions. For example, a sensor may include computer code configured to be executed in one or more processors, and may include hardware logic/electrical circuitry controlled by the computer code. These example devices are provided herein purposes of illustration, and are not intended to be limiting. Embodiments of the present disclosure may be implemented in further types of devices, as would be known to persons skilled in the relevant art(s).

At least some embodiments of the disclosure have been directed to computer program products comprising such logic (e.g., in the form of software) stored on any computer useable medium. Such software, when executed in one or more data processing devices, causes a device to operate as described herein.

While various embodiments of the present disclosure have been described above, it should be understood that they have been presented by way of example only, and not limitation. It will be apparent to persons skilled in the relevant art that various changes in form and detail can be made therein without departing from the spirit and scope of the disclosure. Thus, the breadth and scope of the present disclosure should not be limited by any of the above-described exemplary embodiments, but should be defined only in accordance with the following claims and their equivalents. The foregoing description has been presented for the purposes of illustration and description. It is not intended to be exhaustive or to limit the disclosure to the precise form disclosed. Many modifications and variations are possible in light of the above teaching. Further, it should be noted that any or all of the aforementioned alternate implementations may be used in any combination desired to form additional hybrid implementations of the disclosure.

Further, although specific implementations of the disclosure have been described and illustrated, the disclosure is not to be limited to the specific forms or arrangements of parts so described and illustrated. The scope of the disclosure is to be defined by the claims appended hereto, any future claims submitted here and in different applications, and their equivalents.

What is claimed is:

1. A method for detecting pedestrians comprising:
receiving an image of a region near a vehicle;
processing the image using a first neural network to determine one or more locations where pedestrians are likely located within the image;
processing the one or more locations of the image using a second neural network to determine that a pedestrian is present; and
notifying a driving assistance system or automated driving system that the pedestrian is present.

2. The method of claim 1, wherein the first neural network comprises a network trained to identify approximate locations within images that likely contain pedestrians.

3. The method of claim 1, wherein the first neural network generates a saliency map indicating most likely locations of pedestrians.

4. The method of claim 3, wherein the saliency map comprises a lower resolution than the image.

5. The method of claim 1, wherein the second neural network processes the one or more locations within the image at full resolution.

6. The method of claim 1, wherein the second neural network comprises a deep neural network classifier that has been trained using cropped ground truth bounding boxes to determine that a pedestrian is or is not present.

7. The method of claim 1, wherein determining that a pedestrian is present comprises determining whether a pedestrian is present in each of the one or more locations.

8. The method of claim 1, further comprising determining a location of the pedestrian in relation to the vehicle based on the image.

9. The method of claim 1, further comprising determining a priority for the one or more locations, wherein processing the one or more locations comprises processing using the second neural network based on the priority.

10. A system comprising:
one or more cameras positioned on a vehicle to capture an image of a region near the vehicle;
a saliency component configured to process the image using a first neural network to generate a low resolution saliency map indicating one or more regions where pedestrians are most likely located within the image;
a detection component configured to process the one or more regions using a second neural network to determine, for each of one or more regions, whether a pedestrian is present; and
a notification component configured to provide a notification indicating a presence or absence of pedestrians.

11. The system of claim 10, wherein the saliency map comprises a lower resolution than the image.

12. The system of claim 10, wherein the detection component uses the second neural network to process the one or more locations within the image at full resolution.

13. The system of claim 10, wherein the second neural network comprises a deep neural network classifier that has been trained using cropped ground truth bounding boxes to determine that a pedestrian is or is not present.

14. The system of claim 10, wherein the detection component is configured to determine whether a pedestrian is present in each of the one or more regions.

15. The system of claim 10, wherein the notification component is configured to provide the notification to one or more of an output device to notify a driver and an automated driving system.

16. The system of claim 10, further comprising a driving maneuver component configured to determine a driving maneuver for the vehicle to perform.

17. Computer readable storage media storing instructions that, when executed by one or more processors, cause the one or more processors to:
receive an image of a region near a vehicle;
process the image using a first neural network to determine one or more locations where pedestrians are likely located within the image;
process the one or more locations of the image using a second neural network to determine that a pedestrian is present; and
provide an indication to a driving assistance system or automated driving system that the pedestrian is present.

18. The computer readable storage media of claim 17, wherein processing the image using a first neural network comprises generating a saliency map indicating the one or more locations, wherein the saliency map comprises a lower resolution than the image.

19. The computer readable storage media of claim 17, wherein the instructions cause the one or more processors to determine whether a pedestrian is present in each of the one or more locations.

20. The computer readable storage media of claim 17, wherein the instructions cause the one or more processor to determine a priority for the one or more locations and process the one or more locations based on the priority.
